(19) United States
(12) Patent Application Publication
(10) Pub. No.: US 2025/0297665 A1
(43) Pub. Date: Sep. 25, 2025

(54) SHOCK BYPASS TUBE HAVING TUBULAR EXTENSION

(71) Applicant: Shock Therapy Suspension, Inc., Duluth, GA (US)

(72) Inventor: Justin Smith, Wittmann, AZ (US)

(21) Appl. No.: 18/609,674

(22) Filed: Mar. 19, 2024

(51) Int. Cl. F16F 9/48; B60G 13/08; B60G 17/08; F16F 9/19; F16F 9/32; F16F 9/34

(52) U.S. Cl. CPC F16F 9/48; F16F 9/19; F16F 9/3271; F16F 9/34; B60G 13/08; B60G 17/08; B60G 2202/24; B60G 2204/62; B60G 2206/41; B60G 2500/104; B60G 2500/11; B60G 2600/21; B60G 2800/162; B60G 2800/916; F16F 2222/12; F16F 2226/04; F16F 2228/066; F16F 2230/36

(57) ABSTRACT

A shock bypass tube having a tubular extension for a hydraulic shock of a vehicle is provided. The tubular extension is secured to an end portion of the shock bypass tube having a reduced tubular portion. The tubular extension increases the length of the bump stage or zone of the hydraulic shock when a piston of the hydraulic shock travels beyond oil outlet apertures of the shock bypass tube. The increased length of the bump stage or zone enhances the performance and ride quality of the hydraulic shock.

### BACKGROUND OF THE INVENTION

### Technical Field

This invention relates generally to a shock bypass tube for a vehicle and more particularly to a shock bypass tube having a tubular extension.

### State of the Art

Shock bypass tubes are provided within hydraulic shocks of a vehicle, including off road vehicles (ORVs), such as utility terrain vehicles (UTVs). A shock bypass tube allows oil to bypass the piston of the hydraulic shock as the piston travels up the shock bypass tube. Oil outlet holes are provided along the shock bypass tube and are covered up with valving shims. The holes get smaller in the direction of travel of the piston in the shock bypass tube which makes the hydraulic shock stiffer (less oil flow or bypass). Once the piston passes those oil outlet holes, the piston travels into a non-bypass area (bump stage or zone) of the shock bypass tube and reaches maximum stiffness. This bump stage or zone of the hydraulic shock occurs when the vehicle traverses large bumps or bottoms out based on terrain requiring maximum shock stiffness.

Accordingly, there is a need for a hydraulic shock to accommodate a larger bump stage or zone in order to improve overall performance and ride quality of the hydraulic shock.

### SUMMARY OF THE INVENTION

The present invention relates to a shock bypass tube having a tubular extension. The tubular extension provides an enlarged bump stage or zone for a piston traveling within a hydraulic shock. The enlarged bump stage or zone provides enhanced performance to the hydraulic shock by providing maximum stiffness within a larger range of the bump stage or zone.

An embodiment includes a hydraulic shock device comprising: a shock bypass tube provided with a tubular wall having an outer cylindrical surface; a plurality of pairs of fluid outlet apertures provided in the tubular wall and extending through the outer cylindrical surface, wherein each of the plurality of pairs of fluid outlet apertures are respectively covered by a corresponding plurality of one way valving shims, and wherein the corresponding plurality of one way valving shims extend over each of the plurality of pairs of fluid outlet apertures; and a tubular extension member provided on an end portion of the shock bypass tube, wherein the tubular extension member is secured to the end portion having a reduced tubular portion, and wherein the reduced tubular portion is provided with a circumferentially extending stepped portion which extends inwardly from the tubular wall of the shock bypass tube.

The tubular extension member may be provided with a cylindrical tubular wall portion having first and second opposite end portions thereof, and wherein the first opposite end portion may fit over the reduced tubular portion and may be secured thereto. The reduced tubular portion may be a first reduced tubular portion, and wherein the second opposite end portion may be provided with a second reduced tubular portion. The circumferentially extending stepped portion may be a first circumferentially extending stepped portion, and wherein the second reduced tubular portion may be provided with a second circumferentially extending stepped portion which extends inwardly from the cylindrical tubular wall portion of the tubular extension member.

The tubular extension member may be a first tubular extension member, and wherein a second tubular extension member may be secured to the first tubular extension member. The cylindrical tubular wall portion may be a first cylindrical tubular wall portion, and wherein the second tubular extension member may be provided with a second cylindrical tubular wall portion having first and second opposing end portions thereof. The first opposing end portion may fit over the second reduced tubular portion and may be secured thereto. The second opposing end portion may be provided with a third reduced tubular portion. The third reduced tubular portion may be provided with a third circumferentially extending stepped portion which extends inwardly from the second tubular wall portion of the second tubular extension member.

Another embodiment includes a method of assembling a hydraulic shock device comprising: providing a shock bypass tube with a tubular wall having an outer cylindrical surface; providing a plurality of pairs of fluid outlet apertures in the tubular wall and extending through the outer cylindrical surface; covering each of the plurality of pairs of fluid outlet apertures with a corresponding plurality of one way valving shims, wherein the corresponding plurality of one way valving shims extend over each of the plurality of pairs of fluid outlet apertures; providing a tubular extension member on an end portion of the shock bypass tube; securing the tubular extension member to the end portion having a reduced tubular portion; and providing the reduced tubular portion with a circumferentially extending stepped portion which extends inwardly from the tubular wall of the shock bypass tube.

The method may further comprise providing the tubular extension member with a cylindrical tubular wall portion having first and second opposite end portions thereof. The method may further comprise fitting the first opposite end portion over the reduced tubular portion and securing thereto. The method may further comprise providing the reduced tubular portion as a first reduced tubular portion, and providing the second opposite end portion with a second reduced tubular portion. The method may further comprise providing the circumferentially extending stepped portion as a first circumferentially extending stepped portion, and providing the second reduced tubular portion with a second circumferentially extending stepped portion which extends inwardly from the cylindrical tubular wall portion of the tubular extension member.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a frontal perspective view of a shock bypass tube having a tubular extension member according to an embodiment;

FIG. 2 is a longitudinal perspective view of a shock bypass tube having a tubular extension member according to an embodiment;

FIG. 3 is a longitudinal perspective view of a shock bypass tube having a tubular extension member according to an embodiment;

FIG. 4 is a partial cross sectional view of a shock bypass tube having a tubular extension member according to an embodiment;

FIG. 5 is a partial cross sectional view of a shock bypass tube having a tubular extension member according to an embodiment; and

FIG. 6 is a block diagram of steps of a method of assembly of a shock bypass tube having a tubular extension member according to an embodiment.

### DETAILED DESCRIPTION OF EMBODIMENTS OF THE INVENTION

As discussed above, embodiments of the present invention relate to a shock bypass tube having a tubular extension. The tubular extension increases the bump stage or zone in which the piston of the hydraulic shock travels enabling the bump stage or zone to occur sooner in the shock stroke of the piston. The bump stage or zone is increased by the length of the tubular extension. By adding the tubular extension, the bump stage or zone increases and commences sooner in the overall piston stroke. The tubular extension may be, for example, about 2 inches in length.

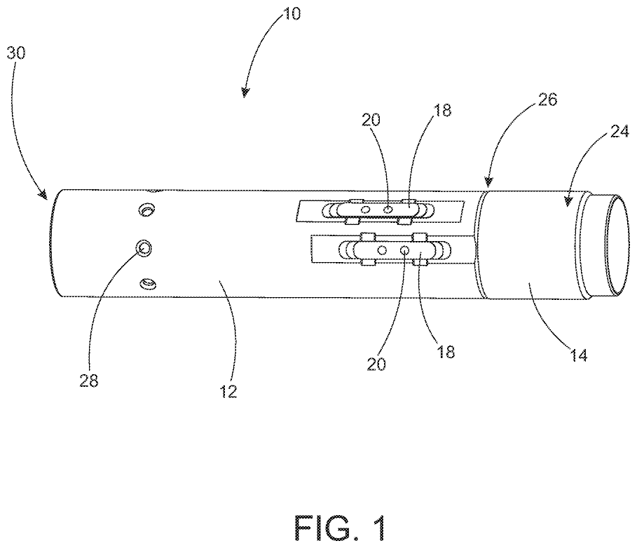

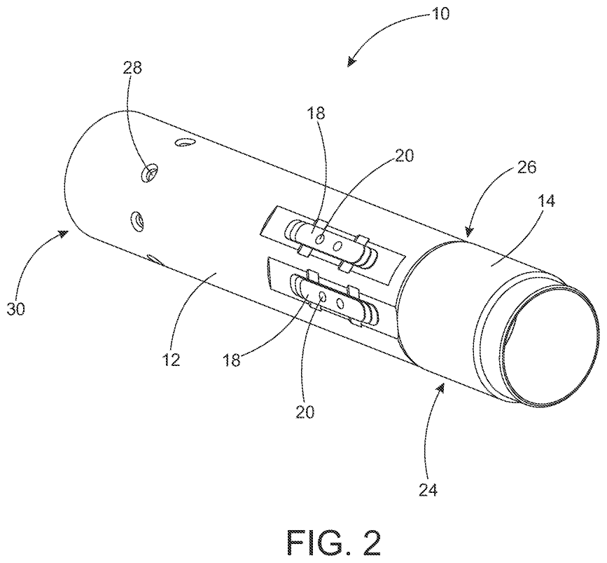

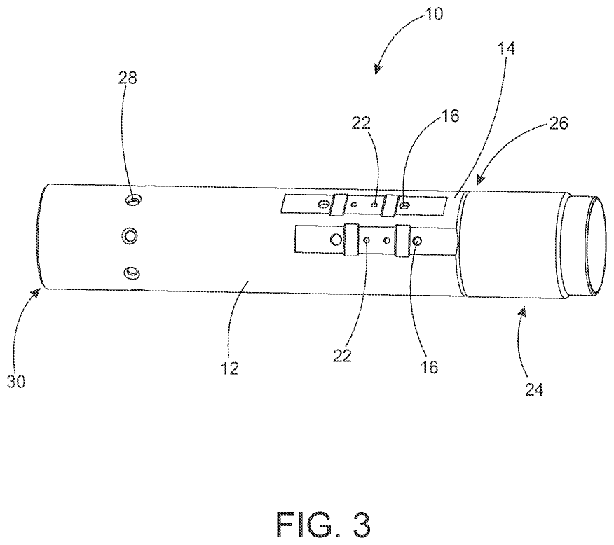

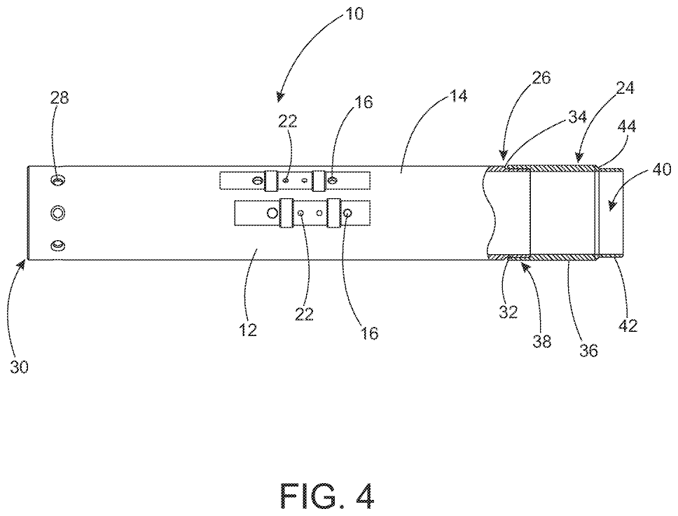

As shown in FIGS. 1-4, a shock bypass tube 10 is provided with a tubular wall 12 having an outer cylindrical surface 14. A plurality of pairs of fluid outlet apertures 16 (See FIGS. 3 and 4) are provided through the tubular wall 12 and extend to the outer cylindrical surface 14. Each of the plurality of pairs of fluid outlet apertures 16 are covered by a corresponding plurality of one-way valving shims 18 that extend over each of the plurality of pairs of fluid outlet apertures 16 (See FIGS. 1 and 2).

The corresponding plurality of one-way valving shims 18 are secured to the tubular wall 12 of the shock bypass tube 10 by corresponding plurality of pairs of rivet fasteners 20. The corresponding plurality of pairs of rivet fasteners 20 are positioned within a central portion of each of the corresponding plurality of one-way valving shims 18. The corresponding plurality of pairs of rivet fasteners 20 are secured to a corresponding plurality of pairs of inner apertures 22 positioned between each of the plurality of pairs of fluid outlet apertures 16 (See FIGS. 3 and 4).

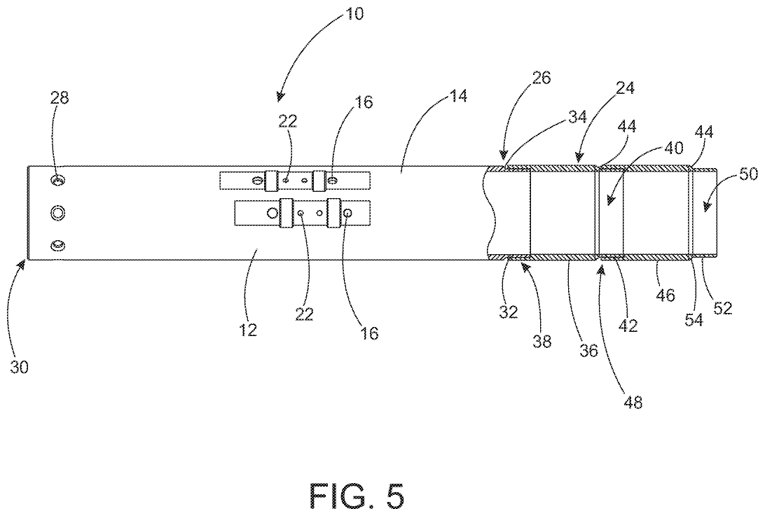

In FIGS. 1-4, a tubular extension member 24 is provided on one end portion 26 of the shock bypass tube 10. A plurality of fastener openings 28 is provided on an opposite end portion 30 of the shock bypass tube 10. The tubular extension member 24 is secured to the one end portion 26 which is provided with a first reduced tubular portion 32 (See FIGS. 4 and 5). The first reduced tubular portion 32 is provided with a first circumferentially extending stepped portion 34 which extends inwardly from the tubular wall 12 of the shock bypass tube 10.

The tubular extension member 24 is provided with a first cylindrical tubular wall portion 36 having opposite end portions 38 and 40 thereof. Opposite end portion 38 fits over the first reduced tubular portion 32 and is secured thereto. Opposite end portion 40 is provided with a second reduced tubular portion 42. The second reduced tubular portion 42 is provided with a second circumferentially extending stepped portion 44 which extends inwardly from the first cylindrical tubular wall portion 36 of the tubular extension member 24. The tubular extension member 24 may be added aftermarket to or in production of shock bypass tube 10.

At least one additional tubular extension member 44 may be provided on the tubular extension member 24 dependent upon a desired performance of the shock bypass tube 10 (See FIG. 5). The additional tubular extension member 44 is provided with a second cylindrical tubular wall portion 46 having opposing end portions 48 and 50 thereof. Opposing end portion 48 fits over the second reduced tubular portion 42 and is secured thereto. Opposing end portion 50 is provided with a third reduced tubular portion 52. The third reduced tubular portion 52 is provided with a third circumferentially extending stepped portion 54 which extends inwardly from the second cylindrical tubular wall portion 46 of the additional tubular extension member 44.

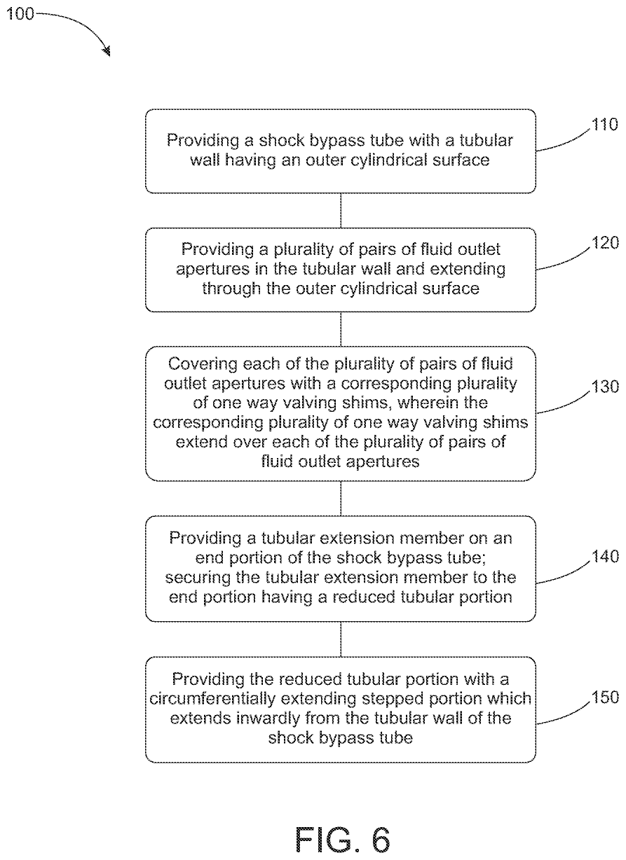

FIG. 6 is a block diagram of steps of a method 100 of assembling a hydraulic shock device. Method 100 comprises providing a shock bypass tube with a tubular wall having an outer cylindrical surface (Step 110); providing a plurality of pairs of fluid outlet apertures in the tubular wall and extending through the outer cylindrical surface (Step 120); covering each of the plurality of pairs of fluid outlet apertures with a corresponding plurality of one way valving shims, wherein the corresponding plurality of one way valving shims extend over each of the plurality of pairs of fluid outlet apertures (Step 130); providing a tubular extension member on an end portion of the shock bypass tube; securing the tubular extension member to the end portion having a reduced tubular portion (Step 140); and providing the reduced tubular portion with a circumferentially extending stepped portion which extends inwardly from the tubular wall of the shock bypass tube (Step 150).

The method further comprises providing the tubular extension member with a cylindrical tubular wall portion having first and second opposite end portions thereof; fitting the first opposite end portion over the reduced tubular portion and securing thereto; providing the reduced tubular portion as a first reduced tubular portion, and providing the second opposite end portion with a second reduced tubular portion; providing the circumferentially extending stepped portion as a first circumferentially extending stepped portion, and providing the second reduced tubular portion with a second circumferentially extending stepped portion which extends inwardly from the cylindrical tubular wall portion of the tubular extension member.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A hydraulic shock device comprising:
a shock bypass tube provided with a tubular wall having an outer cylindrical surface;
a plurality of pairs of fluid outlet apertures provided in the tubular wall and extending through the outer cylindrical surface, wherein each of the plurality of pairs of fluid outlet apertures are respectively covered by a corresponding plurality of one way valving shims, and wherein the corresponding plurality of one way valving shims extend over each of the plurality of pairs of fluid outlet apertures; and
a tubular extension member provided on an end portion of the shock bypass tube, wherein the tubular extension member is secured to the end portion having a reduced tubular portion, and wherein the reduced tubular portion is provided with a circumferentially extending stepped portion which extends inwardly from the tubular wall of the shock bypass tube.

2. The hydraulic shock device of claim 1, wherein the tubular extension member is provided with a cylindrical tubular wall portion having first and second opposite end portions thereof, and wherein the first opposite end portion fits over the reduced tubular portion and is secured thereto.

3. The hydraulic shock device of claim 2, wherein the reduced tubular portion is a first reduced tubular portion, and wherein the second opposite end portion is provided with a second reduced tubular portion.

4. The hydraulic shock device of claim 3, wherein the circumferentially extending stepped portion is a first circumferentially extending stepped portion, and wherein the second reduced tubular portion is provided with a second circumferentially extending stepped portion which extends inwardly from the cylindrical tubular wall portion of the tubular extension member.

5. The hydraulic shock device of claim 4, wherein the tubular extension member is a first tubular extension member, and wherein a second tubular extension member is secured to the first tubular extension member.

6. The hydraulic shock device of claim 5, wherein the cylindrical tubular wall portion is a first cylindrical tubular wall portion, and wherein the second tubular extension member is provided with a second cylindrical tubular wall portion having first and second opposing end portions thereof.

7. The hydraulic shock device of claim 6, wherein the first opposing end portion fits over the second reduced tubular portion and is secured thereto.

8. The hydraulic shock device of claim 7, wherein the second opposing end portion is provided with a third reduced tubular portion.

9. The hydraulic shock device of claim 8, wherein the third reduced tubular portion is provided with a third circumferentially extending stepped portion which extends inwardly from the second tubular wall portion of the second tubular extension member.

10. A method of assembling a hydraulic shock device comprising:
providing a shock bypass tube with a tubular wall having an outer cylindrical surface;
providing a plurality of pairs of fluid outlet apertures in the tubular wall and extending through the outer cylindrical surface;
covering each of the plurality of pairs of fluid outlet apertures with a corresponding plurality of one way valving shims, wherein the corresponding plurality of one way valving shims extend over each of the plurality of pairs of fluid outlet apertures;
providing a tubular extension member on an end portion of the shock bypass tube; securing the tubular extension member to the end portion having a reduced tubular portion; and
providing the reduced tubular portion with a circumferentially extending stepped portion which extends inwardly from the tubular wall of the shock bypass tube.

11. The method of claim 10, further comprising providing the tubular extension member with a cylindrical tubular wall portion having first and second opposite end portions thereof.

12. The method of claim 11, further comprising fitting the first opposite end portion over the reduced tubular portion and securing thereto.

13. The method of claim 12, further comprising providing the reduced tubular portion as a first reduced tubular portion, and providing the second opposite end portion with a second reduced tubular portion.

14. The method of claim 13, further comprising providing the circumferentially extending stepped portion as a first circumferentially extending stepped portion, and providing the second reduced tubular portion with a second circumferentially extending stepped portion which extends inwardly from the cylindrical tubular wall portion of the tubular extension member.
